(19) United States
(12) Patent Application Publication
(10) Pub. No.: US 2016/0269787 A1
(43) Pub. Date: Sep. 15, 2016

(54) DATA PROCESSING METHOD AND APPARATUS FOR COUNTING AUDIENCE RATING

(71) Applicant: Beijing Gridsum Technology Co., Ltd., Beijing (CN)

(72) Inventors: Fei LIN, Beijing (CN); Chao Hong, Beijing (CN); Dan He, Beijing (CN); Zhiyuan Wang, Beijing (CN)

(21) Appl. No.: 15/158,263

(22) Filed: May 18, 2016

Related U.S. Application Data
(63) Continuation-in-part of application No. PCT/CN2014/090081, filed on Oct. 31, 2014.

(30) Foreign Application Priority Data
Nov. 20, 2013 (CN) 201310589985.1

(51) Int. Cl. H04N 21/475; H04N 21/258; H04N 21/25; H04N 21/466

(52) U.S. Cl. CPC H04N 21/4756; H04N 21/4667; H04N 21/25891; H04N 21/252

(57) ABSTRACT

The disclosure discloses a data processing method for counting an audience rating. The data processing method for counting an audience rating includes that: a live broadcast time of a currently played video is acquired; the live broadcast time of the video is sent to a server; and the server is notified to calculate an audience rating of the video according to the live broadcast time of the video. By means of the disclosure, the accuracy of counting the audience rating can be improved.

### TECHNICAL FIELD OF THE INVENTION

The disclosure relates to the field of internet multimedia, and in particular to a data processing method and apparatus for counting an audience rating.

### BACKGROUND OF THE INVENTION

A video which had been played in a television channel in the past cannot be played. Currently, a live video can be replayed. Thus, a user may not watch a programme at any current moment. For example, it is nine o'clock at night, but the user is actually watching a television programme which was played at eight o'clock at night. Thus, when an audience rating is counted, programmes which are actually watched by each user should be considered as a contribution of the user to an audience rating. For example, the audience rating to which the user contributes in the above-mentioned example should be laid on the programme which was played at eight o'clock.

Current solutions refer to direct calculation of an audience rating in accordance with a moment at which a playing behaviour of an audience happens instead of a moment corresponding to a played content. For example, if an audience watches a programme, which was played at eight o'clock, at nine o'clock, the audience rating to which the audience contributes will be laid on a programme which is being played at nine o'clock instead of the actually watched programme which was played at eight o'clock due to calculation in accordance with the moment at which the playing behaviour happens in the traditional art. Thus, an audience rating counting result will be not accurate aiming at the situation of live broadcast of replaying.

An effective solution is not proposed currently for the problem in the traditional art that an audience rating is inaccurately counted.

### SUMMARY OF THE INVENTION

The disclosure is mainly intended to provide a data processing method and apparatus for counting an audience rating, which are used to solve the problem in the traditional art that an audience rating is inaccurately counted.

In order to achieve the aim, according to one aspect of the disclosure, a data processing method for counting an audience rating is provided. The data processing method for counting an audience rating according to the disclosure may include that: a live broadcast time of a currently played video is acquired; the live broadcast time of the video is sent to a server; and the server is notified to calculate an audience rating of the video according to the live broadcast time of the video.

Furthermore, the step that the live broadcast time of the currently played video is acquired may include that: a live broadcast moment corresponding to a start position of the video is acquired; a start live broadcast moment of the video and an end live broadcast moment of the video are calculated according to the live broadcast moment corresponding to the start position of the video; and when the video is out of a played state, the live broadcast time of the currently played video is obtained according to the start live broadcast moment of the video and the end live broadcast moment of the video.

Furthermore, the step that the start live broadcast moment of the video and the end live broadcast moment of the video are calculated according to the live broadcast moment corresponding to the start position of the video may include that: the start position of the video is acquired; a start offset of the video with respect to the start position when the video is in a start play position is acquired; an end offset of the video at a play ending position with respect to the start position is acquired; the start live broadcast moment of the video is calculated according to the start offset and the live broadcast moment corresponding to the start position of the video; and the end live broadcast moment of the video is calculated according to the end offset and the live broadcast moment corresponding to the start position of the video.

Furthermore, it is characterized in that the step that the live broadcast time of the currently played video is acquired may include that: the live broadcast moment corresponding to the start position of the video is acquired; the start live broadcast moment of the video and a current live broadcast moment of the video are calculated according to the live broadcast moment corresponding to the start position of the video; and in a video playing process, a current live broadcast time of the currently played video is obtained periodically according to the start live broadcast moment of the video and the current live broadcast moment of the video.

Furthermore, the step that the start live broadcast moment of the video and the current live broadcast moment of the video are calculated according to the live broadcast moment corresponding to the start position of the video may include that: the start position of the video is acquired; the start offset of the video with respect to the start position when the video is in the start play position is acquired; a current offset of the video at a current playing position with respect to the start position is acquired; the start live broadcast moment of the video is calculated according to the start offset and the live broadcast moment corresponding to the start position of the video; and the current live broadcast moment of the video is calculated according to the current offset and the live broadcast moment corresponding to the start position of the video.

Furthermore, the step that the live broadcast time of the video is sent to the server may include that: after the live broadcast time of the currently played video is obtained, the live broadcast time of the video is sent to the server; or after the current live broadcast time of the currently played video is obtained, the current live broadcast time of the video is sent to the server.

In order to achieve the aim, according to another aspect of the disclosure, a data processing apparatus for counting an audience rating is provided. The data processing apparatus for counting an audience rating according to the disclosure may include: an acquisition unit, configured to acquire a live broadcast time of a currently played video; a sending unit, configured to send the live broadcast time of the video to a server; and a calculation unit, configured to notify the server to calculate an audience rating of the video according to the live broadcast time of the video.

Furthermore, the acquisition unit may include: a first acquisition module, configured to acquire a live broadcast moment corresponding to a start position of the video; a first calculation module, configured to calculate a start live broadcast moment of the video and an end live broadcast moment of the video according to the live broadcast moment corresponding to the start position of the video; and a first determination module, configured to obtain the live broadcast time of the currently played video according to the start live broadcast moment of the video and the end live broadcast moment of the video when the video is out of a played state.

Furthermore, the first calculation module may include: a first start position acquisition sub-module, configured to acquire the start position of the video; a first start offset acquisition sub-module, configured to acquire a start offset of the video with respect to the start position when the video is in a start play position; a first end offset acquisition sub-module, configured to acquire an end offset of the video at a play ending position with respect to the start position; a first calculation sub-module, configured to calculate the start live broadcast moment of the video according to the start offset and the live broadcast moment corresponding to the start position of the video; and a second calculation sub-module, configured to calculate the end live broadcast moment of the video according to the end offset and the live broadcast moment corresponding to the start position of the video.

Furthermore, the acquisition unit may include: a second acquisition module, configured to acquire the live broadcast moment corresponding to the start position of the video; a second calculation module, configured to calculate the start live broadcast moment of the video and a current live broadcast moment of the video according to the live broadcast moment corresponding to the start position of the video; and a second determination module, configured to obtain a current live broadcast time of the currently played video periodically according to the start live broadcast moment of the video and the current live broadcast moment of the video in a video playing process.

Furthermore, the second calculation module may include: a second start position acquisition sub-module, configured to acquire the start position of the video; a second start offset acquisition sub-module, configured to acquire the start offset of the video with respect to the start position when the video is in the start play position; a second end offset acquisition sub-module, configured to acquire a current offset of the video at a current playing position with respect to the start position; a third calculation sub-module, configured to calculate the start live broadcast moment of the video according to the start offset and the live broadcast moment corresponding to the start position of the video; and a fourth calculation sub-module, configured to calculate the current live broadcast moment of the video according to the current offset and the live broadcast moment corresponding to the start position of the video.

Furthermore, the sending unit may include a first sending module and/or a second sending module, wherein the first sending module is configured to send the live broadcast time of the video to the server after the live broadcast time of the currently played video is obtained; and the second sending module is configured to send the current live broadcast time of the video to the server after the current live broadcast time of the currently played video is obtained.

By means of the disclosure, the live broadcast time of the currently played video is acquired; the live broadcast time of the video is sent to the server; and the server is notified to calculate the audience rating of the video according to the live broadcast time of the video. The problem in the traditional art that an audience rating is inaccurately counted is solved, thereby achieving an effect of accurately counting an audience rating.

### BRIEF DESCRIPTION OF THE DRAWINGS

The drawings forming a part of the disclosure are intended to provide further understanding of the disclosure. The schematic embodiments and descriptions of the disclosure are intended to explain the disclosure, and do not form improper limits to the disclosure. In the drawings:

FIG. 1 is a flowchart of a data processing method for counting an audience rating according to a first embodiment of the disclosure;

FIG. 2 is a flowchart of a data processing method for counting an audience rating according to a second embodiment of the disclosure;

FIG. 3 is a flowchart of a data processing method for counting an audience rating according to a third embodiment of the disclosure;

FIG. 4 is a diagram of a data processing apparatus for counting an audience rating according to a first embodiment of the disclosure;

FIG. 5 is a diagram of a data processing apparatus according to a second embodiment of the disclosure; and

FIG. 6 is a diagram of a data processing apparatus according to a third embodiment of the disclosure.

### DETAILED DESCRIPTION OF THE INVENTION

It is important to note that the embodiments of the disclosure and the characteristics in the embodiments can be combined under the condition of no conflicts. The disclosure is described in detail below with reference to the drawings and the embodiments.

In order to make those skilled in the art better understand the solution of the disclosure, the technical solutions in the embodiments of the disclosure are clearly and completely described below with reference to the drawings in the embodiments of the disclosure. Obviously, the described embodiments are only a part of the embodiments of the disclosure, not all of the embodiments. On the basis of the embodiments of the disclosure, all other embodiments obtained on the premise of no creative work of those skilled in the art shall fall within the protection scope of the disclosure.

It is important to note that the description and claims of the disclosure and terms ‘first’, ‘second’ and the like in the drawings are intended to distinguish similar objects, and do not need to describe a specific sequence or a precedence order. It should be understood that used data can be exchanged under appropriate conditions, in order that the embodiments of the disclosure described here can be implemented in a sequence except sequences graphically shown or described here. In addition, terms ‘include’ and ‘have’ and any inflexions thereof are intended to cover non-exclusive inclusions. For example, processes, methods, systems, products or devices containing a series of steps or units do not need to clearly show those steps or units, and can include other inherent steps or units of these processes, methods, products or devices, which are not clearly shown.

The embodiments of the disclosure provide a data processing method for counting an audience rating. The method can run on a computer processing apparatus. The data processing method for counting an audience rating, provided by the embodiment of the disclosure, is described below in detail with reference to the drawings.

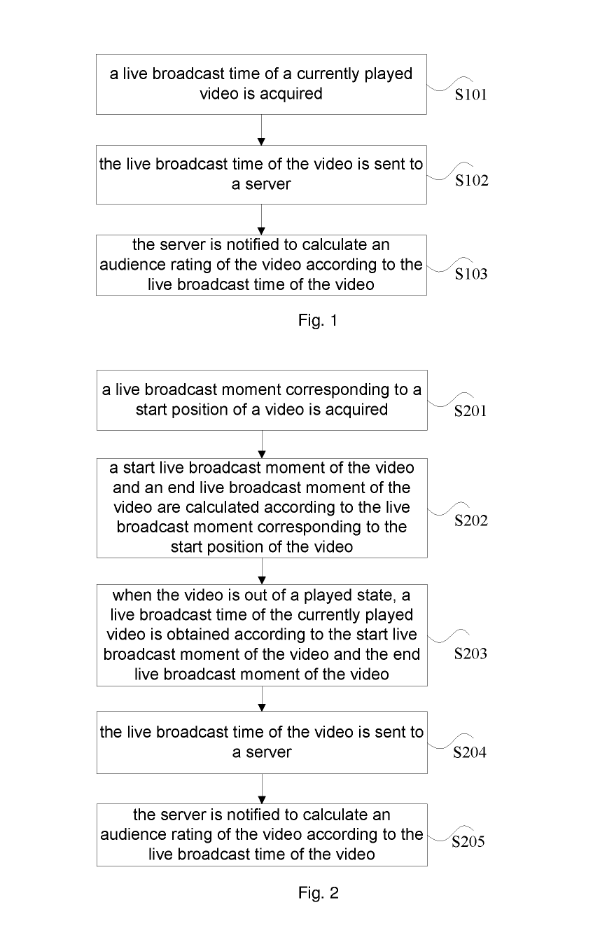

FIG. 1 is a flowchart of a data processing method for counting an audience rating according to a first embodiment of the disclosure. As shown in FIG. 1, the method includes the steps as follows.

Step S101: A live broadcast time of a currently played video is acquired. When a user watches a live programme in a non-live time period, in order to accurately acquire an audience rating of the watched live programme, it is necessary to determine a live broadcast time of the live programme watched by the user firstly. The live broadcast time refers to a playing time of the live programme in a fixed time period instead of a replaying time of the played live programme.

The acquisition of the live broadcast time of the currently played video can refer to the acquisition of a live beginning time of the currently played video, a live broadcast time of a current position, a live ending time or a play continuing time of the video. Namely, the acquisition of the live broadcast time of the currently played video can refer to: the acquisition of a live beginning moment of the currently played video, a live broadcast moment corresponding to the current position, and a live ending moment; or the acquisition of the live beginning moment of the currently played video, the live broadcast moment corresponding to the current position, and a play continuing moment of the video.

For example, it is nine o'clock at night, but the user is actually watching a television programme which was played at eight o'clock at night. The acquired live broadcast time of the current video is eight o'clock at night.

Step S102: The live broadcast time of the video is sent to a server. When playing of the video is ended or the video enters a non-played state from a played state, the acquired live broadcast time of the current video is sent to the server, wherein the non-played state may be a buffer state. In the previous example, the live broadcast time (eight o'clock at night) corresponding to the video is sent to the server. The server can receive the sent live broadcast time, and can establish a corresponding relationship between the video and the live broadcast time of the video to facilitate calculation of an audience rating.

By sending the live broadcast time to the server when playing of the video is ended or the video enters the non-played state from the played state, the timely sending and processing of data can be ensured, thereby avoiding a situation that the data cannot be sent due to errors in a player program or other conditions.

The live broadcast time can be sent to the server by utilizing application layer protocols such as a Hyper Text Transport Protocol (HTTP), transport layer protocols such as a Transport Control Protocol (TCP) and a User Datagram Protocol (UDP), or other network protocols. Data sending and receiving technologies used in the embodiments of the disclosure can adopt, but not limited to, the network transport protocols.

Step S103: The server is notified to calculate an audience rating of the video according to the live broadcast time of the video. Sending, by a client, the live broadcast time of the video to the server can be regarded as sending a notification about calculation of the audience rating to the server. After receiving the live broadcast time, the server performs data processing on the received live broadcast time. Due to the fact that processed data is the live broadcast time of the video instead of a watching time of the video, the audience rating of the video, calculated using the server, falls within the live broadcast time of the video, thereby making the audience rating of the video calculated accurately.

FIG. 2 is a flowchart of a data processing method for counting an audience rating according to a second embodiment of the disclosure. As shown in FIG. 2, the method includes the steps as follows.

In order to facilitate explanations and understandings, several concepts are explained firstly:

1, video, which refers to a segment of data content allowable to be watched, the same video referring to the same video data;

2, playing, which refers to a video behaviour state, the same video being played at different positions for many times;

3, moment, which refers to a time point such as 2013-11-1 14:31:23;

4, time length, which refers to a time interval, wherein for example, a time interval between 2013-11-1 14:31:23 and 2013-11-1 14:33:23 is 120 seconds, namely a time length is 120 seconds;

5, playing position offset (offset for short), if a video is played for x seconds at a normal speed beginning from a start position of the video to a certain frame of picture of the video, an offset of a position where the picture is located being x seconds; and

6, moment corresponding to start position of video, wherein it can be known, from a definition of an offset above, that the offset of the start position of the video is 0, this position is unique to a video, and therefore a moment corresponding to the start position of the video is also unique.

Step S201: A live broadcast moment corresponding to a start position of a video is acquired. The start position of the video can be directly acquired via a video player. When beginning to play the video, the player can acquire a moment (for example 2013-9-10 18:00) corresponding to the start position of a currently played video from a server such as a video information management server. Namely, the live broadcast moment corresponding to the start position of the video, recorded by the player, is 2013-9-10 18:00.

Step S202: A start live broadcast moment of the video and an end live broadcast moment of the video are calculated according to the live broadcast moment corresponding to the start position of the video. After the live broadcast moment corresponding to the start position of the video is acquired, the start live broadcast moment corresponding to a play beginning moment of the video can be determined, and then an offset of the start position of the video with respect to a play ending position of the video is determined after playing of the video is ended, thereby determining the end live broadcast moment of the video.

The video player can be a Flash video player or a Silverlight video player. A playing position of the video for the Flash video player can be determined according to a time attribute of a NetStream class, and the playing position of the video for the Silverlight video player can be determined according to a Position attribute of a MediaElement class.

Step S203: When the video is out of a played state, a live broadcast time of the currently played video is obtained according to the start live broadcast moment of the video and the end live broadcast moment of the video.

A time period from the end live broadcast moment of the video to the start live broadcast moment of the video is a playing time length of the currently played video. The start live broadcast moment of the video is equal to an actual live broadcast moment of the video, and therefore the obtained live broadcast time of the currently played video is a playing time of the video on a television for example.

The player can obtain the live broadcast time of the currently played video, and therefore an audience rating of the current video, calculated according to the live broadcast time of the currently played video, can accurately contribute to a video played in the television in this time period.

Step S204: The live broadcast time of the video is sent to the server. The live broadcast time of the currently played video can be sent to the server by utilizing application layer protocols such as an HTTP, transport layer protocols such as a TCP and a UDP, or other network protocols. Data sending and receiving technologies used in the embodiments of the disclosure can adopt, but not limited to, the network transport protocols.

Step S205: The server is notified to calculate the audience rating of the video according to the live broadcast time of the video. After receiving the live broadcast time, the server performs data processing on the received live broadcast time. Due to the fact that processed data is the live broadcast time of the video instead of a watching time of the video, the audience rating of the video, calculated using the server, falls within the live broadcast time of the video, thereby making the audience rating of the video calculated accurately.

Preferably, the step that the start live broadcast moment of the video and the end live broadcast moment of the video are calculated according to the live broadcast moment corresponding to the start position of the video includes the steps as follows. Step S301: The start position of the video is acquired. The start position of the video is a live broadcast moment corresponding to a first frame of the video instead of a live broadcast moment corresponding to a start play position of the video, namely a beginning moment of the video, acquired from the server. For example, 2013-9-10 18:00 in Step S201 is taken as the start position of the video.

Step S302: A start offset of the video with respect to the start position when the video is in the start play position is acquired. The start play position of the video can be the start position of the video or a playing position of the video entering a played state from a pause state or a buffer state. If the start play position is the start position of the video, the start offset is 0. If the start play position is a playing moment of the video entering the played state from the pause state or the buffer state, the start offset is a difference between the start play position of the video and the start position of the video.

If the video is played for 5 seconds at a normal speed beginning from the start position of the video to a certain frame of picture of the video, an offset of a position where the picture is located is 5 seconds.

A time attribute value of a NetStream class can be provided in a Flash video player, and a Position attribute value of a MediaElement class can be provided in a Silverlight video player. Both the time attribute value and the Position attribute value can be used for showing a current playing position of the video. When the attribute value is 0, it can be shown that the current video begins to be played from the start position. When the attribute value is not 0, it can be shown that the current video begins to be played from a certain position in the video. Thus, when the user begins to watch the video from a certain point of interest, the audience rating of the currently played video can be accurately calculated.

Step S303: An end offset of the video at a play ending position with respect to the start position is acquired. When the video is at the play ending position, playing of the current video can be ended or the current video is switched from the played state to the buffer state or the pause state. Due to the fact that the live broadcast time of the start position of the video can be acquired, a play ending time of the video can be determined according to the live broadcast time of the start position of the video and the end offset.

Similarly, the end offset can be calculated according to the time attribute time of the NetStream class in the Flash video player, and can be calculated according to the Position attribute value of the MediaElement class in the Silverlight video player.

Step S304: A start live broadcast moment of the video is calculated according to the start offset and the live broadcast moment corresponding to the start position of the video. For example, if the live broadcast moment corresponding to the start position of the video is 2013-9-10 18:00:00 and the start offset is 50 seconds, the start live broadcast moment of the video is 2013-9-10 18:00:50.

Step S305: An end live broadcast moment of the video is calculated according to the end offset and the live broadcast moment corresponding to the start position of the video. For example, if the live broadcast moment corresponding to the start position of the video is 2013-9-10 18:00:00 and the end offset is 2 minutes, the end live broadcast moment of the video is 2013-9-10 18:02:00.

In the above-mentioned example, data sent to the server includes the start live broadcast moment (2013-9-10 18:00:50) and the end live broadcast moment (2013-9-10 18:02:00). The audience rating of the video in the time period can be accurately reflected by calculating the audience rating of the video according to the two moments.

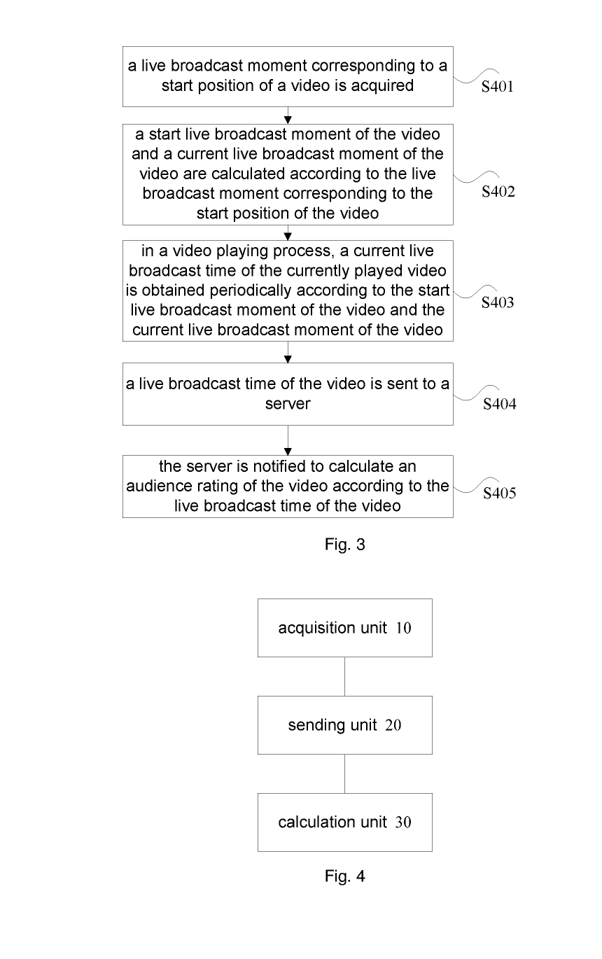

FIG. 3 is a flowchart of a data processing method for counting an audience rating according to a third embodiment of the disclosure. As shown in FIG. 3, the method includes the steps as follows.

Step S401: A live broadcast moment corresponding to a start position of a video is acquired. The start position of the video can be directly acquired via a video player.

When beginning to play the video, the player can acquire a moment (for example 2013-9-10 18:00) corresponding to the start position of a currently played video from a server such as a video information management server. Namely, the live broadcast moment corresponding to the start position of the video, recorded by the player, is 2013-9-10 18:00.

Step S402: A start live broadcast moment of the video and a current live broadcast moment of the video are calculated according to the live broadcast moment corresponding to the start position of the video. The current live broadcast moment of the video can be any moment in a video playing process, the video player can update the current live broadcast moment at a pre-set time interval, the time interval can be 30 seconds or 1 minute, and a specific time interval can be determined according to a current network situation and requirements of the server or the player. The current playing moment of the video can be determined according to an offset of the current playing position of the video with respect to the start position.

The video player can be a Flash video player or a Silverlight video player. A playing position of the video for the Flash video player can be determined according to a time attribute of a NetStream class, and the playing position of the video for the Silverlight video player can be determined according to a Position attribute of a MediaElement class.

Step S403: In the video playing process, a current live broadcast time of the currently played video is obtained periodically according to the start live broadcast moment of the video and the current live broadcast moment of the video. A length of a time period from the current live broadcast moment of the video to the start live broadcast moment of the video is a playing time length of the currently played video. The start live broadcast moment of the video is equal to an actual live broadcast moment of the video, and therefore the obtained live broadcast time of the currently played video is a playing time of the video on a television for example.

The current live broadcast time of the currently played video can be obtained periodically according to the start live broadcast moment of the video and the current live broadcast moment of the video based on the settings of a client.

The player can obtain the live broadcast time of the currently played video, and therefore an audience rating of the current video, calculated according to the live broadcast time of the currently played video, can accurately contribute to a video played in the television in this time period.

It is important to note that in the embodiment, the time period can be a time period between two moments, namely a time length.

Step S404: The live broadcast time of the video is sent to the server. The live broadcast time of the currently played video can be sent to the server by utilizing application layer protocols such as an HTTP, transport layer protocols such as a TCP and a UDP, or other network protocols. Data sending and receiving technologies used in the embodiments of the disclosure can adopt, but not limited to, the network transport protocols.

In the embodiment, the current live broadcast moment can be sent to the server at a pre-set moment interval. In the second embodiment of the disclosure, the end live broadcast moment is sent to the server when a video state changes, wherein the end live broadcast moment can serve as a special form of the current live broadcast moment.

It is important to note that the live broadcast time sent to the server can be in a form of 2013-9-10 18:00:00-2013-9-10 18:02:00 or 20130910180000-20130910180200. It is only required to contain the start live broadcast moment and the current live broadcast moment.

Step S405: The server is notified to calculate the audience rating of the video according to the live broadcast time of the video. After receiving the live broadcast time, the server performs data processing on the received live broadcast time. Due to the fact that processed data is the live broadcast time of the video instead of a watching time of the video, the audience rating of the video, calculated using the server, falls within the live broadcast time of the video, thereby making the audience rating of the video calculated accurately.

Preferably, the step that the start live broadcast moment of the video and the current live broadcast moment of the video are calculated according to the live broadcast moment corresponding to the start position of the video includes the steps as follows.

Step S501: The start position of the video is acquired. The start position of the video is a live broadcast moment corresponding to a first frame of the video instead of a live broadcast moment corresponding to a start play position of the video.

Step S502: A start offset of the video with respect to the start position when the video is in the start play position is acquired. The start play position of the video can be the start position of the video or a playing position of the video entering a played state from a pause state or a buffer state. If the start play position is the start position of the video, the start offset is 0. If the start play position is a playing moment of the video entering the played state from the pause state or the buffer state, the start offset is a difference between the start play position of the video and the start position of the video.

A time attribute value of a NetStream class can be provided in a Flash video player, and a Position attribute value of a MediaElement class can be provided in a Silverlight video player. Both the time attribute value and the Position attribute value can be used for showing a current playing position of the video. When the attribute value is 0, it can be shown that the current video begins to be played from the start position. When the attribute value is not 0, it can be shown that the current video begins to be played from a certain position in the video. Thus, when the user begins to watch the video from a certain point of interest, the audience rating of the currently played video can be accurately calculated.

Step S503: A current offset of the video at a current playing position with respect to the start position is acquired. When the video is at the current playing position, the current video can be in a played state to a non-played state. Due to the fact that the live broadcast time of the start position of the video can be acquired, a current playing time of the video can be determined according to the live broadcast time of the start position of the video and the current offset.

Similarly, the current offset can be calculated according to the time attribute time of the NetStream class in the Flash video player, and can be calculated according to the Position attribute value of the MediaElement class in the Silverlight video player.

Step S504: A start live broadcast moment of the video is calculated according to the start offset and the live broadcast moment corresponding to the start position of the video. For example, if the live broadcast moment corresponding to the start position of the video is 2013-9-10 18:00:00 and the start offset is 50 seconds, the start live broadcast moment of the video is 2013-9-10 18:00:50.

Step S505: A current live broadcast moment of the video is calculated according to the current offset and the live broadcast moment corresponding to the start position of the video. For example, if the live broadcast moment corresponding to the start position of the video is 2013-9-10 18:00:00 and the current offset is 2 minutes, the current live broadcast moment of the video is 2013-9-10 18:02:00.

In the above-mentioned example, data sent to the server includes the start live broadcast moment (2013-9-10 18:00:50) and the current live broadcast moment (2013-9-10 18:02:00). The audience rating of the video in the time period can be accurately reflected by calculating the audience rating of the video according to the two moments.

The data processing method provided by the embodiments of the disclosure can count the live broadcast time of the video from play beginning to play ending and can also count the current live broadcast time of the video from play beginning to a certain moment in playing. Thus, counting data can be sent to the server by means of different sending frequencies. However, sending protocols can be identical.

After the live broadcast time of the video is obtained, the live broadcast time of the video is sent to the server. When the video enters the non-played state from the played state, the live broadcast time of the video is sent to the server, wherein the non-played state can be a pause state, a buffer state or an error state.

After the current live broadcast time of the video is obtained, the current live broadcast time of the video is sent to the server. When the video is in the played state or the non-played state, the player can send the current live broadcast time to the server according to a pre-set sending interval.

From the above description, it can be seen that since a video content watched by the user corresponds to the live broadcast time of the video, the audience rating counted in the embodiments of the disclosure is irrelevant to the watching time of the user, but relevant to the video content watched by the user. The accurate audience rating can be counted.

The embodiments of the disclosure also provide a data processing apparatus for counting an audience rating.

The data processing method according to the embodiments of the disclosure can be executed via the data processing apparatus provided by the embodiments of the disclosure. The data processing apparatus according to the embodiments of the disclosure can be configured to execute the data processing method provided by the embodiments of the disclosure.

FIG. 4 is a diagram of a data processing apparatus for counting an audience rating according to a first embodiment of the disclosure. As shown in FIG. 4, the data processing apparatus includes: an acquisition unit 10, a sending unit 20 and a calculation unit 30.

The acquisition unit 10 is configured to acquire a live broadcast time of a currently played video. When a user watches a live programme in a non-live time period, in order to accurately acquire an audience rating of the watched live programme, it is necessary to determine a live broadcast time of the live programme watched by the user firstly. The live broadcast time refers to a playing time of the live programme in a fixed time period instead of a replaying time of the played live programme.

The acquisition of the live broadcast time of the currently played video can refer to the acquisition of a beginning time of the currently played video, a current time, an ending time or a play continuing time of the video.

For example, it is nine o'clock at night, but the user is actually watching a television programme which was played at eight o'clock at night. The acquired live broadcast time of the current video is eight o'clock at night.

In the embodiment of the disclosure, the sending unit 20 includes a first sending module and/or a second sending module, wherein the first sending module is configured to send the live broadcast time of the video to a server after the live broadcast time of the currently played video is obtained; and the second sending module is configured to send a current live broadcast time of the video to the server after the current live broadcast time of the currently played video is obtained.

The sending unit 20 is configured to send the live broadcast time of the video to the server. When playing of the video is ended or the video enters a non-played state from a played state, the acquired live broadcast time of the current video is sent to the server, wherein the non-played state may be a buffer state. In the previous example, the live broadcast time (eight o'clock at night) corresponding to the video is sent to the server. The server can receive the sent live broadcast time, and can establish a corresponding relationship between the video and the live broadcast time of the video to facilitate calculation of an audience rating.

By sending the live broadcast time to the server when playing of the video is ended or the video enters the non-played state from the played state, the timely sending and processing of data can be ensured, thereby avoiding a situation that the data cannot be sent due to errors in a player program or other conditions.

The live broadcast time can be sent to the server by utilizing application layer protocols such as an HTTP, transport layer protocols such as a TCP and a UDP, or other network protocols. Data sending and receiving technologies used in the embodiments of the disclosure can adopt, but not limited to, the network transport protocols.

The calculation unit 30 is configured to notify a server to calculate an audience rating of the video according to the live broadcast time of the video. Sending, by a client, the live broadcast time of the video to the server can be regarded as sending a notification about calculation of the audience rating to the server. After receiving the live broadcast time, the server performs data processing on the received live broadcast time. Due to the fact that processed data is the live broadcast time of the video instead of a watching time of the video, the audience rating of the video, calculated using the server, falls within the live broadcast time of the video, thereby making the audience rating of the video calculated accurately.

FIG. 5 is a diagram of a data processing apparatus according to a second embodiment of the disclosure. As shown in FIG. 5, the data processing apparatus includes an acquisition unit 10, a sending unit 20 and a calculation unit 30, wherein the acquisition unit 10 includes a first acquisition module 101, a first calculation module 102 and a first determination module 103. The sending unit 20 and the calculation unit 30 shown in FIG. 5 are identical to the sending unit 20 and the calculation unit 30 in the embodiment shown in FIG. 4 in function, which do not need to be described in detail here.

The first acquisition module 101 is configured to acquire a live broadcast moment corresponding to a start position of a video. The start position of the video can be directly acquired via a video player. When beginning to play the video, the player can acquire a moment (for example 2013-9-10 18:00) corresponding to the start position of a currently played video from a server such as a video information management server. Namely, the live broadcast moment corresponding to the start position of the video, recorded by the player, is 2013-9-10 18:00.

The first calculation module 102 is configured to calculate a start live broadcast moment of the video and an end live broadcast moment of the video according to the live broadcast moment corresponding to the start position of the video. After the live broadcast moment corresponding to the start position of the video is acquired, the start live broadcast moment corresponding to a play beginning moment of the video can be determined, and then an offset of the start position of the video with respect to a play ending position of the video is determined after playing of the video is ended, thereby determining the end live broadcast moment of the video.

The video player can be a Flash video player or a Silverlight video player. A playing position of the video for the Flash video player can be determined according to a time attribute of a NetStream class, and the playing position of the video for the Silverlight video player can be determined according to a Position attribute of a MediaElement class.

The first determination module 103 is configured to obtain a live broadcast time of the currently played video according to the start live broadcast moment of the video and the end live broadcast moment of the video when the video is out of a played state. A time period from the end live broadcast moment of the video to the start live broadcast moment of the video is a playing time length of the currently played video. The start live broadcast moment of the video is equal to an actual live broadcast moment of the video, and therefore the obtained live broadcast time of the currently played video is a playing time of the video on a television for example.

The player can obtain the live broadcast time of the currently played video, and therefore an audience rating of the current video, calculated according to the live broadcast time of the currently played video, can accurately contribute to a video played in the television in this time period.

Furthermore, the first calculation module 102 includes: a first start position acquisition sub-module, a first start offset acquisition sub-module, a first end offset acquisition sub-module, a first calculation sub-module and a second calculation sub-module.

The first start position acquisition sub-module is configured to acquire the start position of the video. The start position of the video is a live broadcast moment corresponding to a first frame of the video instead of a live broadcast moment corresponding to a start play position of the video.

The first start offset acquisition sub-module is configured to acquire a start offset of the video with respect to the start position when the video is in the start play position. The start play position of the video can be the start position of the video or a playing position of the video entering a played state from a pause state or a buffer state. If the start play position is the start position of the video, the start offset is 0. If the start play position is a playing moment of the video entering the played state from the pause state or the buffer state, the start offset is a difference between the start play position of the video and the start position of the video.

If the video is played for 5 seconds at a normal speed beginning from the start position of the video to a certain frame of picture of the video, an offset of a position where the picture is located is 5 seconds.

A time attribute value of a NetStream class can be provided in a Flash video player, and a Position attribute value of a MediaElement class can be provided in a Silverlight video player. Both the time attribute value and the Position attribute value can be used for showing a current playing position of the video. When the attribute value is 0, it can be shown that the current video begins to be played from the start position. When the attribute value is not 0, it can be shown that the current video begins to be played from a certain position in the video. Thus, when the user begins to watch the video from a certain point of interest, the audience rating of the currently played video can be accurately calculated.

The first end offset acquisition sub-module is configured to acquire an end offset of the video at a play ending position with respect to the start position. When the video is at the play ending position, playing of the current video can be ended or the current video is switched from the played state to the buffer state or the pause state.

Due to the fact that the live broadcast time of the start position of the video can be acquired, a play ending time of the video can be determined according to the live broadcast time of the start position of the video and the end offset.

Similarly, the end offset can be calculated according to the time attribute time of the NetStream class in the Flash video player, and can be calculated according to the Position attribute value of the MediaElement class in the Silverlight video player.

The first calculation sub-module is configured to calculate a start live broadcast moment of the video according to the start offset and the live broadcast moment corresponding to the start position of the video. For example, if the live broadcast moment corresponding to the start position of the video is 2013-9-10 18:00:00 and the start offset is 50 seconds, the start live broadcast moment of the video is 2013-9-10 18:00:50.

The second calculation sub-module is configured to calculate an end live broadcast moment of the video according to the end offset and the live broadcast moment corresponding to the start position of the video. For example, if the live broadcast moment corresponding to the start position of the video is 2013-9-10 18:00:00 and the end offset is 2 minutes, the end live broadcast moment of the video is 2013-9-10 18:02:00.

In the above-mentioned example, data sent to the server includes the start live broadcast moment (2013-9-10 18:00:50) and the end live broadcast moment (2013-9-10 18:02:00). The audience rating of the video in the time period can be accurately reflected by calculating the audience rating of the video according to the two moments.

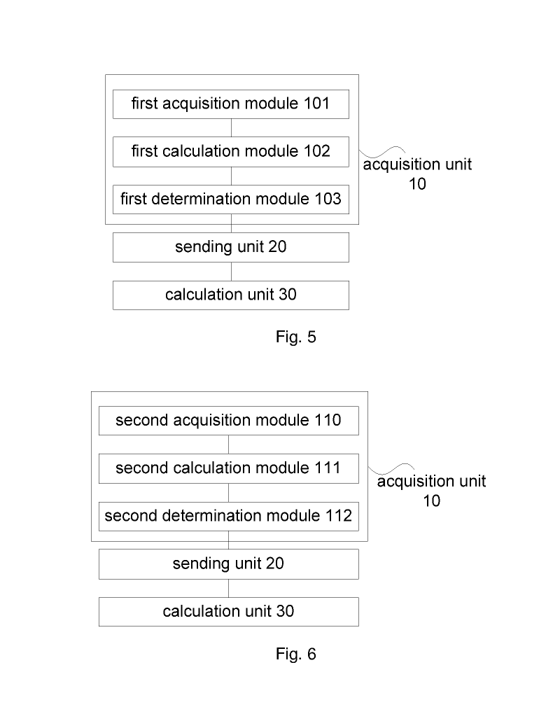

FIG. 6 is a diagram of a data processing apparatus according to a third embodiment of the disclosure. As shown in FIG. 6, the data processing apparatus includes an acquisition unit 10, a sending unit 20 and a calculation unit 30, wherein the acquisition unit 10 includes a second acquisition module 110, a second calculation module 111 and a second determination module 112.

The second acquisition module 110 is configured to acquire a live broadcast moment corresponding to a start position of a video. The start position of the video can be directly acquired via a video player.

When beginning to play the video, the player can acquire a moment (for example 2013-9-10 18:00) corresponding to the start position of a currently played video from a server such as a video information management server. Namely, the live broadcast moment corresponding to the start position of the video, recorded by the player, is 2013-9-10 18:00.

The second calculation module 111 is configured to calculate a start live broadcast moment of the video and a current live broadcast moment of the video according to the live broadcast moment corresponding to the start position of the video. The current live broadcast moment of the video can be any moment in a video playing process, the video player can update the current live broadcast moment at a pre-set time interval, the time interval can be 30 seconds or 1 minute, and a specific time interval can be determined according to a current network situation and requirements of the server or the player. The current playing moment of the video can be determined according to an offset of the current playing position of the video with respect to the start position.

The video player can be a Flash video player or a Silverlight video player. A playing position of the video for the Flash video player can be determined according to a time attribute of a NetStream class, and the playing position of the video for the Silverlight video player can be determined according to a Position attribute of a MediaElement class.

The second determination module 112 is configured to obtain a current live broadcast time of the currently played video periodically according to the start live broadcast moment of the video and the current live broadcast moment of the video in the video playing process. A time period from the current live broadcast moment of the video to the start live broadcast moment of the video is a playing time length of the currently played video. The start live broadcast moment of the video is equal to an actual live broadcast moment of the video, and therefore the obtained live broadcast time of the currently played video is a playing time of the video on a television for example.

The current live broadcast time of the currently played video can be obtained periodically according to the start live broadcast moment of the video and the current live broadcast moment of the video based on the settings of a client.

The player can obtain the live broadcast time of the currently played video, and therefore an audience rating of the current video, calculated according to the live broadcast time of the currently played video, can accurately contribute to a video played in the television in this time period.

Furthermore, the second calculation module 111 can calculate the start live broadcast moment of the video and the current live broadcast moment of the video according to the live broadcast moment corresponding to the start position of the video.

A second start position acquisition sub-module is configured to acquire a start position of the video. The start position of the video is a live broadcast moment corresponding to a first frame of the video instead of a live broadcast moment corresponding to a start play position of the video.

A second start offset acquisition sub-module is configured to acquire a start offset of the video with respect to the start position when the video is in a start play position. The start play position of the video can be the start position of the video or a playing position of the video entering a played state from a pause state or a buffer state. If the start play position is the start position of the video, the start offset is 0. If the start play position is a playing moment of the video entering the played state from the pause state or the buffer state, the start offset is a difference between the start play position of the video and the start position of the video.

A time attribute value of a NetStream class can be provided in a Flash video player, and a Position attribute value of a MediaElement class can be provided in a Silverlight video player. Both the time attribute value and the Position attribute value can be used for showing a current playing position of the video. When the attribute value is 0, it can be shown that the current video begins to be played from the start position. When the attribute value is not 0, it can be shown that the current video begins to be played from a certain position in the video. Thus, when the user begins to watch the video from a certain point of interest, the audience rating of the currently played video can be accurately calculated.

A second end offset acquisition sub-module is configured to acquire a current offset of the video at a current playing position with respect to the start position. When the video is at the current playing position, the current video can be in a played state to a non-played state. Due to the fact that the live broadcast time of the start position of the video can be acquired, a current playing time of the video can be determined according to the live broadcast time of the start position of the video and the current offset.

Similarly, the current offset can be calculated according to the time attribute time of the NetStream class in the Flash video player, and can be calculated according to the Position attribute value of the MediaElement class in the Silverlight video player.

A third calculation sub-module is configured to calculate a start live broadcast moment of the video according to the start offset and the live broadcast moment corresponding to the start position of the video. For example, if the live broadcast moment corresponding to the start position of the video is 2013-9-10 18:00:00 and the start offset is 50 seconds, the start live broadcast moment of the video is 2013-9-10 18:00:50.

A fourth calculation sub-module is configured to calculate a current live broadcast moment of the video according to the current offset and the live broadcast moment corresponding to the start position of the video. For example, if the live broadcast moment corresponding to the start position of the video is 2013-9-10 18:00:00 and the current offset is 2 minutes, the current live broadcast moment of the video is 2013-9-10 18:02:00.

In the above-mentioned example, data sent to the server includes the start live broadcast moment (2013-9-10 18:00:50) and the current live broadcast moment (2013-9-10 18:02:00). The audience rating of the video in the time period can be accurately reflected by calculating the audience rating of the video according to the two moments.

The data processing method provided by the embodiments of the disclosure can count the live broadcast time of the video from play beginning to play ending and can also count the current live broadcast time of the video from play beginning to a certain moment in playing. Thus, counting data can be sent to the server by means of different sending frequencies. However, sending protocols can be identical.

After the live broadcast time of the video is obtained, the live broadcast time of the video is sent to the server. When the video enters the non-played state from the played state, the live broadcast time of the video is sent to the server, wherein the non-played state can be a pause state, a buffer state or an error state.

After the current live broadcast time of the video is obtained, the current live broadcast time of the video is sent to the server. When the video is in the played state or the non-played state, the player can send the current live broadcast time to the server according to a pre-set sending interval.

From the above description, it can be seen that since a video content watched by the user corresponds to the live broadcast time of the video, the audience rating counted in the embodiments of the disclosure is irrelevant to the watching time of the user, but relevant to the video content watched by the user. The accurate audience rating can be counted.

The embodiments of the disclosure also provide a computer storage medium. The computer storage medium can store a program which is configured to execute part or all of the steps in the data processing method for counting an audience rating.

It is important to note that in order to simply describe each of the above-mentioned method embodiments, it is expressed as a series of motion assemblies. However, those skilled in the art should know that the disclosure is not limited by a described motion sequence since certain steps can be executed in other sequences or at the same time according to the disclosure. Secondly, those skilled in the art should know that the described embodiments in the description belong to preferred embodiments, and involved motions and modules may not be necessary to the disclosure.

In the above-mentioned embodiments, the description of each embodiment is emphasized. A part which is not described in detail in a certain embodiment can refer to relevant descriptions of the other embodiments.

In some embodiments provided by the disclosure, it should be understood that the disclosed apparatus can be implemented in other modes. For example, the apparatus embodiments described above are only schematic. For example, a division of the units is only a logical function division. There can be additional division modes during actual implementation. For example, a plurality of units or components can be combined or integrated to another system, or some features can be omitted or may not be executed. In addition, mutual coupling or direct coupling or communication connection which is displayed or discussed can be indirect coupling or communication connection via some interfaces, apparatuses or units, and can be in an electric form or other forms.

Units explained as separate parts may be or may not be separated physically. Parts displayed as units may be or may not be physical units. Namely, they may be located at a place or may be distributed on a plurality of network units. Part or all of the units can be selected according to actual requirements to achieve the aims of the solutions of the embodiments.

In addition, all functional units in all embodiments of the disclosure may be integrated in a processing unit. Each unit may exist individually and physically, or two or more units may be integrated in a unit. The integrated unit can be implemented in a form of hardware or can be implemented in a form of a software function unit.

If the integrated unit is implemented in a form of a software function unit or is sold or used as an independent product, the integrated unit can be stored in a computer readable storage medium. On the basis of the understanding, an essential part of the technical solution of the disclosure or a part contributing to the traditional art or all or part of the technical solution can be embodied in a form of a software product. The computer software product is stored in a storage medium, including a plurality of instructions configured to enable a computer device which may be a personal computer, a server, a network device or the like to execute all or part of the steps of the method according to each embodiment of the disclosure. The storage medium includes: various media capable of storing program codes, such as a U disk, a Read-Only Memory (ROM), a Random Access Memory (RAM), a mobile hard disk, a magnetic disc or an optical disc.

The above is only the preferred embodiments of the disclosure, and is not intended to limit the invention. There can be various modifications and variations in the disclosure for those skilled in the art. Any modifications, equivalent replacements, improvements and the like within the spirit and principle of the disclosure shall fall within the protection scope of the invention.

What is claimed is:

1. A data processing method for counting an audience rating, comprising:
acquiring a live broadcast time of a currently played video;
sending the live broadcast time of the video to a server; and
notifying the server to calculate an audience rating of the video according to the live broadcast time of the video.

2. The data processing method according to claim 1, wherein acquiring the live broadcast time of the currently played video comprises:
acquiring a live broadcast moment corresponding to a start position of the video;
calculating a start live broadcast moment of the video and an end live broadcast moment of the video according to the live broadcast moment corresponding to the start position of the video; and
obtaining the live broadcast time of the currently played video according to the start live broadcast moment of the video and the end live broadcast moment of the video when the video is out of a played state.

3. The data processing method according to claim 2, wherein calculating the start live broadcast moment of the video and the end live broadcast moment of the video according to the live broadcast moment corresponding to the start position of the video comprises:
acquiring the start position of the video;
acquiring a start offset of the video with respect to the start position when the video is in a start play position;
acquiring an end offset of the video at a play ending position with respect to the start position;
calculating the start live broadcast moment of the video according to the start offset and the live broadcast moment corresponding to the start position of the video; and
calculating the end live broadcast moment of the video according to the end offset and the live broadcast moment corresponding to the start position of the video.

4. The data processing method according to claim 1, wherein acquiring the live broadcast time of the currently played video comprises:
acquiring the live broadcast moment corresponding to the start position of the video;
calculating the start live broadcast moment of the video and a current live broadcast moment of the video according to the live broadcast moment corresponding to the start position of the video; and
obtaining a current live broadcast time of the currently played video periodically according to the start live broadcast moment of the video and the current live broadcast moment of the video in a video playing process.

5. The data processing method according to claim 4, wherein calculating the start live broadcast moment of the video and the current live broadcast moment of the video according to the live broadcast moment corresponding to the start position of the video comprises:
acquiring the start position of the video;
acquiring the start offset of the video with respect to the start position when the video is in the start play position;
acquiring a current offset of the video at a current playing position with respect to the start position;
calculating the start live broadcast moment of the video according to the start offset and the live broadcast moment corresponding to the start position of the video; and
calculating the current live broadcast moment of the video according to the current offset and the live broadcast moment corresponding to the start position of the video.

6. The data processing method according to claim 2, wherein sending the live broadcast time of the video to the server comprises:
sending the live broadcast time of the video to the server after the live broadcast time of the currently played video is obtained; or sending the current live broadcast time of the video to the server after the current live broadcast time of the currently played video is obtained.

7. A data processing apparatus for counting an audience rating, comprising:
an acquisition unit, configured to acquire a live broadcast time of a currently played video;
a sending unit, configured to send the live broadcast time of the video to a server; and
a calculation unit, configured to notify the server to calculate an audience rating of the video according to the live broadcast time of the video.

8. The data processing apparatus according to claim 7, wherein the acquisition unit comprises:
a first acquisition module, configured to acquire a live broadcast moment corresponding to a start position of the video;
a first calculation module, configured to calculate a start live broadcast moment of the video and an end live broadcast moment of the video according to the live broadcast moment corresponding to the start position of the video; and
a first determination module, configured to obtain the live broadcast time of the currently played video according to the start live broadcast moment of the video and the end live broadcast moment of the video when the video is out of a played state.

9. The data processing apparatus according to claim 8, wherein the first calculation module comprises:
a first start position acquisition sub-module, configured to acquire the start position of the video;
a first start offset acquisition sub-module, configured to acquire a start offset of the video with respect to the start position when the video is in a start play position;
a first end offset acquisition sub-module, configured to acquire an end offset of the video at a play ending position with respect to the start position;
a first calculation sub-module, configured to calculate the start live broadcast moment of the video according to the start offset and the live broadcast moment corresponding to the start position of the video; and
a second calculation sub-module, configured to calculate the end live broadcast moment of the video according to the end offset and the live broadcast moment corresponding to the start position of the video.

10. The data processing apparatus according to claim 7, wherein the acquisition unit comprises:
a second acquisition module, configured to acquire the live broadcast moment corresponding to the start position of the video;
a second calculation module, configured to calculate the start live broadcast moment of the video and a current live broadcast moment of the video according to the live broadcast moment corresponding to the start position of the video; and
a second determination module, configured to obtain a current live broadcast time of the currently played video periodically according to the start live broadcast moment of the video and the current live broadcast moment of the video in a video playing process.

11. The data processing apparatus according to claim 10, wherein the second calculation module comprises:
a second start position acquisition sub-module, configured to acquire the start position of the video;
a second start offset acquisition sub-module, configured to acquire the start offset of the video with respect to the start position when the video is in the start play position;
a second end offset acquisition sub-module, configured to acquire a current offset of the video at a current playing position with respect to the start position;
a third calculation sub-module, configured to calculate the start live broadcast moment of the video according to the start offset and the live broadcast moment corresponding to the start position of the video; and
a fourth calculation sub-module, configured to calculate the current live broadcast moment of the video according to the current offset and the live broadcast moment corresponding to the start position of the video.

12. The data processing apparatus according to claim 8, wherein the sending unit comprises a first sending module and/or a second sending module, the first sending module being configured to send the live broadcast time of the video to the server after the live broadcast time of the currently played video is obtained; and
the second sending module being configured to send the current live broadcast time of the video to the server after the current live broadcast time of the currently played video is obtained.

13. The data processing method according to claim 4, wherein sending the live broadcast time of the video to the server comprises:
sending the live broadcast time of the video to the server after the live broadcast time of the currently played video is obtained; or sending the current live broadcast time of the video to the server after the current live broadcast time of the currently played video is obtained.

14. The data processing apparatus according to claim 10, wherein the sending unit comprises a first sending module and/or a second sending module, the first sending module being configured to send the live broadcast time of the video to the server after the live broadcast time of the currently played video is obtained; and
the second sending module being configured to send the current live broadcast time of the video to the server after the current live broadcast time of the currently played video is obtained.
